(19) United States
(12) Patent Application Publication
(10) Pub. No.: US 2006/0173698 A1
(43) Pub. Date: Aug. 3, 2006

(54) Approvals management production-rule engine

(75) Inventor: Todd M. Morley, Louisville, CO (US)

Correspondence Address: AKA CHAN LLP / ORACLE, 900 LAFAYETTE STREET, SUITE 710, SANTA CLARA, CA, 95050, US

(73) Assignee: Oracle International Corporation, Redwood Shores, CA (US)

(21) Appl. No.: 11/048,258

(22) Filed: Jan. 31, 2005

(51) Int. Cl. G06Q 99/00; G06F 15/02; G06F 9/46

(52) U.S. Cl. 705/1; 705/9

(57) ABSTRACT

Methods and apparatus for processing of transactions within an approvals management system that utilizes production rules stored in a relational database are disclosed. According to one aspect of the present invention, a management approval system includes a database and an engine. The database is arranged to store a set of production rules, and the engine is arranged to receive data and to utilize the data to process the set of production rules. The data includes a plurality of conditions having associated counters, and the engine is arranged to sort the plurality of conditions using the associated counters into an order and to evaluate the plurality of conditions based on the order.

### BACKGROUND OF THE INVENTION

1. Field of Invention

The present invention relates to database systems. More specifically, the invention relates to an approvals management system which utilizes an efficient production-rule engine.

2. Description of the Related Art

Approvals management systems are often used to process transactions such as business transactions. Most approvals management systems include production rules which are generally of an “if-then” format. By way of example, a production rule may specify that if a certain condition is true, then a particular action should occur. Production rules may be stored in a variety of different data storage mechanisms which include, but are not limited to, databases such as relational databases. A production-rules engine, which is included in an approvals management system, generally receives a data input which satisfies conditions associated with rules, then evaluates production rules based on the conditions in order to generate an approver list, or a list of individuals or units that must approve transactions within the framework of the approvals management system. As will be appreciated by those skilled in the art, a condition, e.g., a transaction amount, is generally satisfied if data that is part of the data input falls within a set of values specified in a condition.

FIG. 1 is a diagrammatic representation of an approvals management system. An approvals management system 100 includes a relational database 108 on which production rules 104 are stored. Relational database 108, as will be appreciated by those skilled in the art, stores data in tables, and substantially all operations on the data are performed using the tables. In some instances, within relational database 108, source code that is associated with functions, procedures, packages, and package bodies associated with a production-rules engine 112 may lack a reference or pointer construct. By way of example, when PL/SQL source code is used as a programming language for production-rule engine 112, there is generally no reference or pointer construct available for use in locating various pieces of data.

Given data 116, production-rules engine 112 uses production rules 104 to generate an approver list 120. Data 116, which may include values that may be associated with conditions for any number of production rules 104 in addition to specifying information associated with a business transaction such as an expense report, is typically evaluated and values associated with conditions included in data 116 are cached. As will be understood by those skilled in the art, a condition may generally have the form of “‘A’ is in ‘B’” where ‘A’ is a value obtained from input data and ‘B’ is a set of values within which the value of ‘A’ falls if the conditions is to be met.

Generally, all production rules 104 are evaluated based on the conditions associated with data 116 to generate approver list 116. Once approver list 120 is generated, approvers included in approver list 120 must all approve the business transaction, e.g., an expense report, specified in data 116 before the business transaction is considered to be fully approved.

With reference to FIG. 2, the steps associated with the execution of a production-rules engine such as production-rules engine 112 of FIG. 1 will be described. A process 200 of executing a production-rules engine begins at step 204 in which a list of rules is obtained for a set of data, e.g., a set of data which is associated with an expense report, at run-time. As previously mentioned, the production rules are typically rules which effectively specify a condition or an antecedent, and an action or actions to take if the condition is met. The action or actions to take if a condition is met may be considered to be a consequence, a consequent, or a production, since a rule produces a production when the rule fires. Once the list of rules is obtained, conditions are checked, and condition values may be cached in step 208. The conditions are generally stored in a database, and are associated with the set of data in that the set of data may include input data that falls within a set of values associated with a condition. Specifically, at run-time during the execution of a production-rules engine, conditions are checked and truth values associated with the conditions are cached. The caching of truth values generally prevents conditions from being re-evaluated. Then, in step 212, a rule that is included in the list of rules is evaluated, and the result of the evaluation is saved using a condition identifier. In some systems, when a rule is found to have a false condition, that rule is disqualified without the need to evaluate the rule based on other conditions associated with the rule.

After the rule is evaluated in step 212, it is determined in step 216 whether all rules in the list have been evaluated. Typically, rules are evaluated one-at-a-time in a substantially random, or non-deterministic, order. If there are more rules to evaluate, process flow returns to step 212 from step 216, and the next rule in the list is evaluated. Alternatively, if it is determined that all rules have been evaluated, the process of executing a production-rules engine is completed. It should be appreciated that once all rules within an approvals management system production-rule system are evaluated, an approver list is generally created.

While evaluating all rules associated with a set of data one-at-a-time in a nondeterministic order is effective in allowing approver lists to be generated, evaluating rules associated with a set of data in such a manner may often be time-consuming. As a result, the execution of an approvals management production-rule engine or, more generally, an overall approvals management process may be relatively inefficient.

The evaluation of all rules associated with a set of data one-at-a-time in a nondeterministic order in order to generate an approver list is often not the only time-consuming process associated with an overall approvals process. The process of obtaining approvals based on the approver list is also typically time consuming, as approvals are processed in a serial manner. That is, approvers listed on an approver list are generally allowed to approve a report such as an expense report one-at-a-time. FIG. 3 is a block diagram representation of a process of “signing off” on an approver list, or of obtaining approval based on an approver list. An expense report 302 has an associated approver list 304 which may include any number of approvers and hence, require any number of approvals. As shown, approver list 304 may include four approvers. Approvers may include pre-approvers, chain-of-authority approvers, and post-approvers. A pre-approver may be a subject matter expert, a chain-of-authority approver may be a manager, and a posts approver may be another subject matter expert.

As shown, expense report 302 is first sent to a first approver 306a listed within approver list 304 for review and approval. If first approver 306a approves the expense report 302, expense report 302 is then sent to the next approver in approver list 304, e.g., a second approver 306b. Once second approver 306b approves expense report 302, then expense report is sent to a third approver 306c for approval. After third approver 306c approves expense report 302, the last approver, namely a fourth approver 306d, is allowed to approve expense report 302. The serial approval of expense report 302 by approvers 306a-d may often be time-consuming and, hence, inefficient.

As it is desirable to increase the efficiency with which a production-rules engine or, more generally, an approvals management system may execute, what is needed is a method and an apparatus which improves the performance of both a rules evaluation process and an approvals process. That is, what is desired is a system which enables the number of production rules that are evaluated to be substantially minimized and allows an approvals process to be performed in a substantially non-serial manner.

### SUMMARY OF THE INVENTION

The present invention relates to the efficient processing of transactions which utilize production rules stored in a relational database. According to one aspect of the present invention, a management approval system includes a database and an engine. The database is arranged to store a set of production rules, and the engine is arranged to receive data and to utilize the data to process the set of production rules. The data includes a plurality of conditions having associated counters, and the engine is arranged to sort the plurality of conditions using the associated counters into an order and to evaluate the plurality of conditions based on the order.

In one embodiment, the associated counters are use counts, and the engine is arranged to sort the plurality of conditions such that a first condition of the plurality of conditions with a highest use count is evaluated first. In another embodiment, the data is associated with a transaction, and the engine arranged to generate at least one ordered list of approvers for the transaction.

An approvals management system which uses a production rules engine to sort conditions such that most used conditions are evaluated first and then uses the evaluated conditions to eliminate production rules from having to be evaluated allows an overall approvals process to operate efficiently. The most used conditions are generally associated with the most production rules. As a result, when such conditions evaluate as being false, the production rules which utilize such conditions may be eliminated in an efficient manner. By eliminating production rules from having to be evaluated when they are effectively irrelevant, the time associated with an approvals process may be substantially minimized.

To further increase the efficiency with which an approvals process may occur, approval requests may be sent in parallel to various approvers. The use of N-tuples to effectively non-uniquely identify approvers allows approvers to be sorted in such a way as to enable a transaction approvals request to be sent to more than one approver at the same time, i.e., a transaction approvals request may be sent to two approvers which are assigned the same non-unique N-tuple substantially simultaneously. An N-tuple is an ordered set characters that is ‘N’ characters long. In addition, allowing for a single transaction such as an expense report to have multiple associated approver lists, e.g., an approver list for each subset of line items of the transaction, further enables an approvals process to be parallelized such that more than one approver may be processing a transaction approvals request associated with the transaction at any given time.

According to another aspect of the present invention, a method for processing a transaction using an approvals management system that includes an engine and a database on which a plurality of production rules are stored involves sorting a plurality of conditions. The plurality of conditions are associated with the transaction, and sorting the plurality of conditions includes ordering the plurality of conditions in an approximately deterministic order. The method also includes evaluating the conditions in the approximately deterministic order, and processing the production rules based on the evaluated conditions. Processing the production rules based on the evaluated conditions includes eliminating or otherwise preventing a first production rule from being evaluated.

In one embodiment, the method also further includes evaluating substantially all production rules of the plurality of production rules that are not eliminated from being evaluated. In such an embodiment, the method may additionally include generating at least one ordered list of approvers for the transaction and sending a notification to a first approver and to a second approver substantially simultaneously or substantially in parallel.

According to still another aspect of the present invention, a method for processing a transaction using an approvals management system includes generating at least one ordered list of approvers for a transaction. The approvers have associated not necessarily unique indicators which may be N-tuples, e.g., more than one approver may be associated with the same N-tuple. The method also includes notifying a plurality of the approvers substantially simultaneously of a request for approval. In one embodiment, the at least one ordered list of approvers for the transaction includes a first list and a second list where the first list is associated with a first subordinate or line item of the transaction and the second list is associated with a second line item of the transaction.

Other features and advantages of the invention will become readily available apparent upon review of the following description in association with the accompanying drawings, where the same or similar structures are designated with the same reference numerals.

### BRIEF DESCRIPTION OF THE DRAWINGS

The invention may best be understood by reference to the following description taken in conjunction with the accompanying drawings in which:

FIG. 1 is a diagrammatic representation of an approvals management system in which production rules are stored in a relational database.

FIG. 2 is a process flow diagram which illustrates the steps associated with a conventional method of executing a production rules engine.

FIG. 3 is a block diagram representation of a process of “signing off” on an approver list, or of obtaining approval based on an approver list.

FIG. 4 is a process flow diagram which illustrates the steps associated with one method of executing a production-rules engine included in an approvals management system in accordance with an embodiment of the present invention.

FIG. 5 is a block diagram representation of a transactions approvals process in accordance with an embodiment of the present invention.

FIG. 6 is a block diagram representation of a transactions approvals process in which individual line items of a transaction may have separate approver lists in accordance with an embodiment of the present invention.

FIG. 7 is a block diagram representation of an approver list hierarchy in accordance with an embodiment of the present invention.

FIG. 8 is a process flow diagram which illustrates one method of processing a transaction, e.g., an expense report, which includes subordinate items with separate approver lists in accordance with an embodiment of the present invention.

FIG. 9 is a diagrammatic representation of a transactions approvals management system in accordance with an embodiment of the present invention.

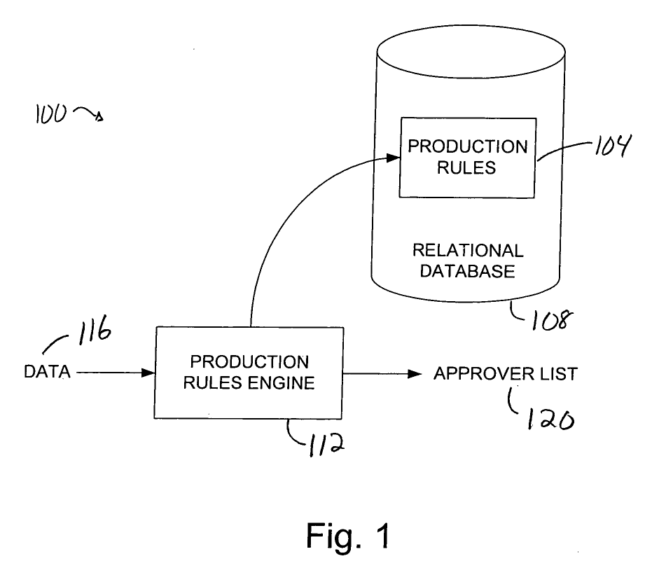

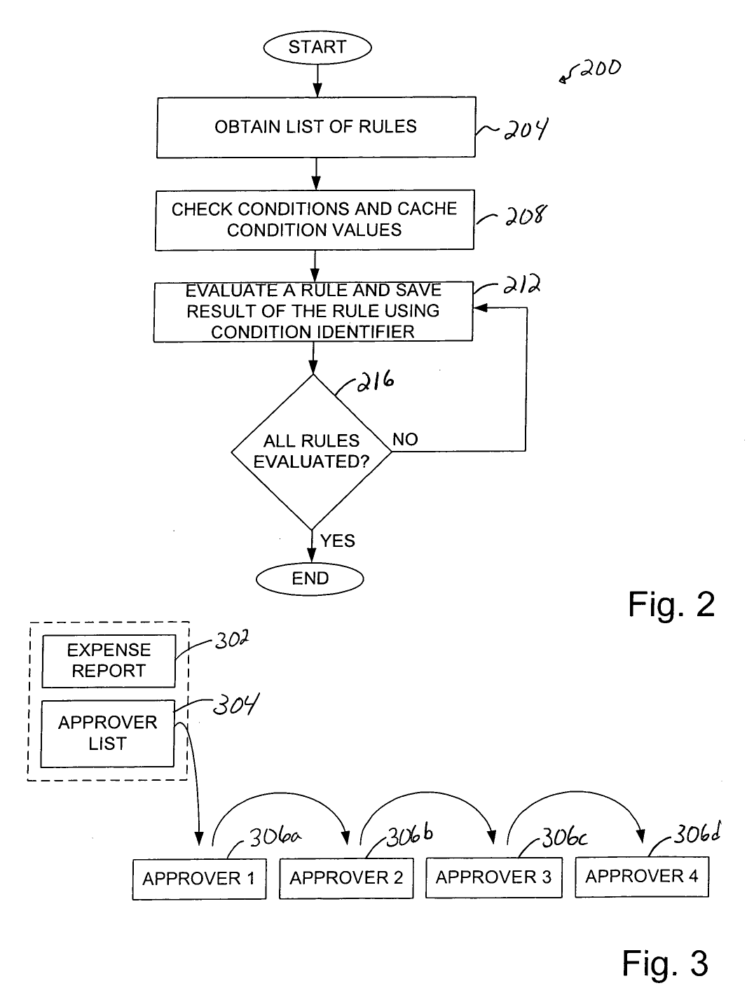

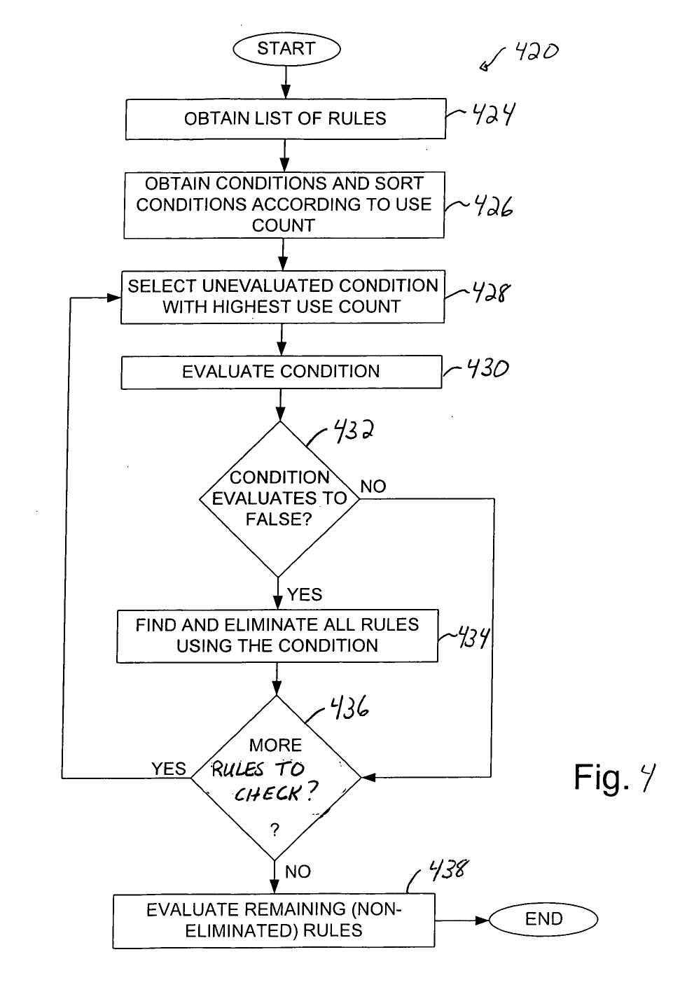

### DETAILED DESCRIPTION OF THE EMBODIMENTS

In the description that follows, the present invention will be described in reference to embodiments that test subsystems on a platform for a software application, such as a database application. However, embodiments of the invention are not limited to any particular architecture, environment, application, or implementation. For example, although embodiments will be described in reference to database applications, the invention may be advantageously applied to any software application. Therefore, the description of the embodiments that follows is for purposes of illustration and not limitation.

Increasing the efficiency with which a production-rules engine of an approvals management system may execute enhances the performance of the approvals management system. When a production-rules engine uses a greedy algorithm, the efficiency with which a set of data may be processed to generate an approver list may be enhanced. In one embodiment, when conditions which evaluate as being false are identified and rules which utilize such conditions are not further evaluated, the efficiency with which a production-rules engine may execute is typically enhanced as the expected or mean number of condition evaluations needed to evaluate a set of rules may be significantly reduced. Additionally, when conditions are evaluated in an order such that the most used conditions are evaluated prior to the least used conditions, i.e., when conditions are evaluated in a descending order of frequency of occurrence in rules, the performance of a production-rules engine or an approvals management system is typically further improved.

When a transaction is submitted to a production-rules engine or, more generally, to an approvals management system, the engine may iterate through conditions which have positive use counts rather than iterating through rules. Each condition is evaluated one time. If the condition evaluates as being false, substantially all rules which use the condition may be eliminated from further consideration as being an applicable rule. If the condition evaluates as being true, then if a rule uses that condition and no other conditions that have not already been evaluated, the rule is determined to be applicable, and is added to a set of applicable rules. Alternatively, if the condition evaluates as being true but a rule uses other conditions which have not already been evaluated, then the rule remains in the set of rules that is still being evaluated. It should be appreciated that a set of applicable rules, in addition to including rules which have conditions that are evaluated as being true, also includes rules which have no conditions.

To further increase the efficiency with which an approvals management system, in particular an approvals management system on which production rules are stored in a relational database, may process transactions, the process of notifying approvers of approval requests may be parallelized such that multiple approvers may be notified approximately simultaneously. Further, accommodating multiple approver lists, e.g., allowing separate approver lists for separate subordinate items of a transaction, enhances the granularity with which transactions may be processed. That is, by allowing subordinate items to have separate approver lists, the control, flexibility, accuracy, and descriptive power in structure approval processes is improved.

FIG. 4 is a process flow diagram which illustrates the steps associated with one method of executing a production-rules engine included in an approvals management system in accordance with an embodiment of the present invention. A process 420 begins at step 424 in which a list of rules associated with the production-rules engine is obtained. In the described embodiment, the list of rules is obtained from a relational database, i.e., the list of rules is stored in a relational database. A relational database is generally a structure on which source code associated with a production-rules engine may be stored as data. The source code may be PL/SQL source code, which is code that does not utilize a pointer construct or a reference construct.

Once the list of rules is obtained, conditions are obtained and sorted according to an indicator in step 426. Typically, conditions may be stored in a table within a database, e.g., the relational database within which rules are also stored. The conditions may be sorted based on indicators which pertain to sets of values associated with the conditions and are included in input data. In general, the indicator by which conditions are stored is a use count which is arranged to indicate how often a particular condition is used or otherwise checked. Sorting the conditions, which are typically included in a set of data provided to a production-rule engine, may involve ordering the conditions such that the condition with the highest use count is first in an ordered list of conditions. That is, conditions may be sorted deterministically. The set of data generally also includes information which pertains to a business transaction, e.g., information associated with an expense report or a requisition request.

In step 428, the condition with the highest use count is selected. More specifically, the as yet unevaluated condition with the highest use count is selected. It should be appreciated that in the event that there is more than one condition with the highest use count, other criteria may be used to select between the plurality of conditions with the highest use count, or one of the plurality of conditions with the highest use count may effectively be selected non-deterministically.

After an unevaluated condition is selected in step 428, the condition is evaluated in step 430. Then, in step 432, it is determined whether the condition evaluates as being false. If the determination is that the condition evaluates as being false, process flow proceeds to step 434 in which substantially all production-rules which use the condition are found and effectively eliminated from consideration, i.e., eliminated from being subsequently evaluated relative to the set of data being processed. A determination is then made in step 436 regarding whether there are more rules to check, i.e., whether there any rules which have not yet been determined to apply or not to apply. In general, substantially all rules will have been processed to determine whether they apply or do not apply before all conditions have been evaluated.

If it is determined in step 436 that there are more rules to check, process flow returns to step 428 in which the unevaluated condition with the highest use count is selected. Alternatively, if it is determined in step 436 that there are no more rules to check, the indication is that the production-rules engine may evaluate rules to generate an appropriate approver list for a transaction. Accordingly, in step 438, substantially all rules which have not effectively been eliminated from consideration are evaluated. Once the rules are evaluated, the process of executing a production-rules engine is completed.

Returning to step 432, if the determination is that the condition being evaluated evaluates to true, the indication is that the rules which use the condition may not be eliminated and, instead, are to be subsequently evaluated. As such, when the condition being evaluated does not evaluate to false, process flow moves directly from step 432 to step 436 in which it is determined whether there are more unevaluated conditions to evaluate.

By effectively eliminating all rules which include conditions that evaluate to false from having to be evaluated, the efficiency with which a production-rules engine may execute is generally improved. The efficiency with which the production-rules engine executes generally increases as the number of rules which may be eliminated from being evaluated increases. Further, as conditions are substantially sorted such that conditions which are often used are evaluated before conditions which are not often used, the elimination of rules from having to be eliminated may also occur efficiently. By way of example, the overall pool of rules which are effectively searched to find rules to be eliminated when a particular condition evaluates to false may be efficiently reduced in size when the most utilized conditions, or the conditions which are associated with the most rules, are evaluated prior to the less utilized conditions. When a highly used condition evaluates to false, a relatively significant number of rules may be eliminated from having to be studied when a subsequent, and typically less used, condition evaluates to false.

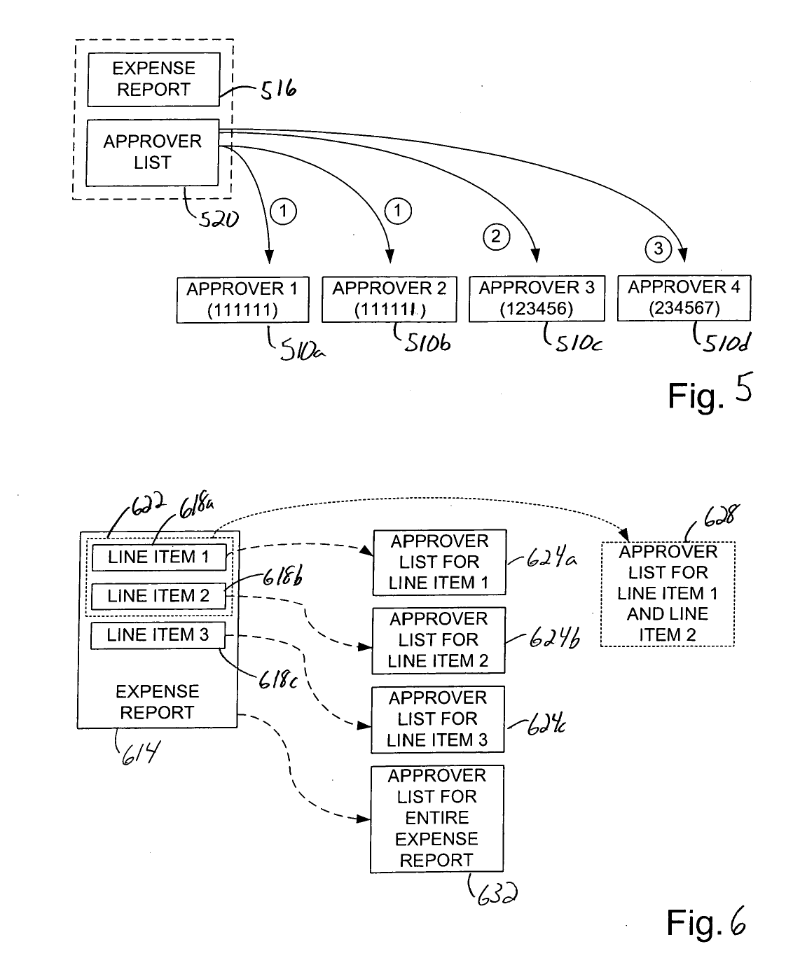

Once an approver list is generated through the use of a production-rules engine, approvers on the list may effectively be contacted in either or both a parallel manner or a serial manner. FIG. 5 is a block diagram representation of a transactions approvals process in accordance with an embodiment of the present invention. An approver list 520, which may be an approver list for an expense report 516, includes typically non-unique indicators associated with approvers 510a-d. Although approver list 520 is shown as being an approver list for expense report 516, it should be appreciated that approver list 520 may be an approver list for substantially any business transaction which may require approval, e.g., a requisition request or a purchase order.

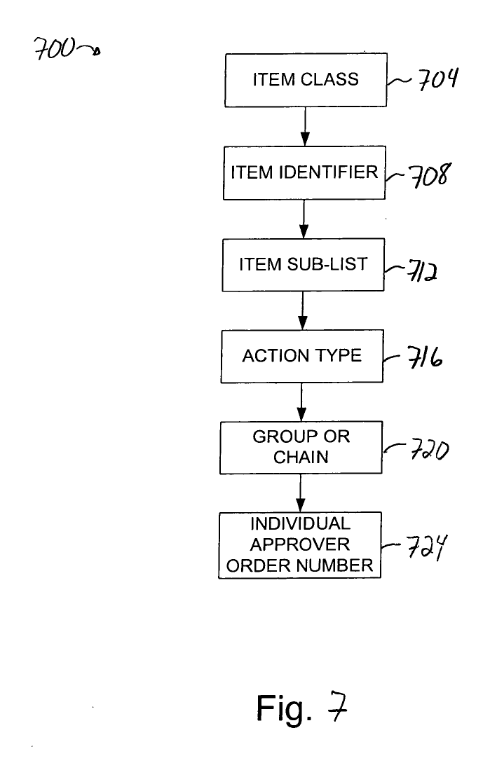

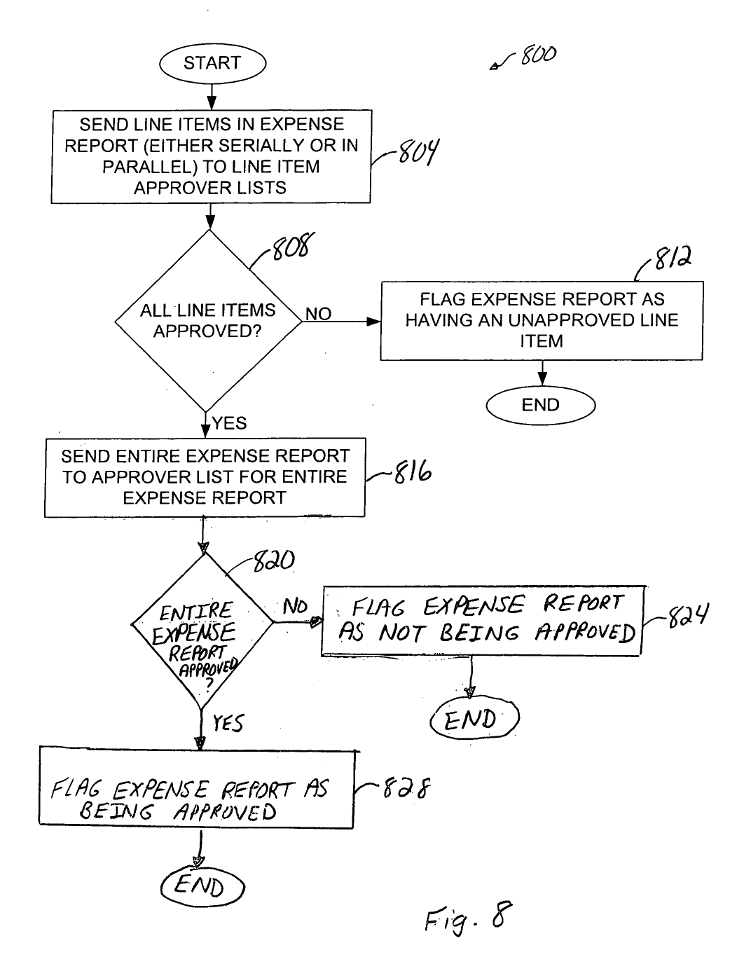

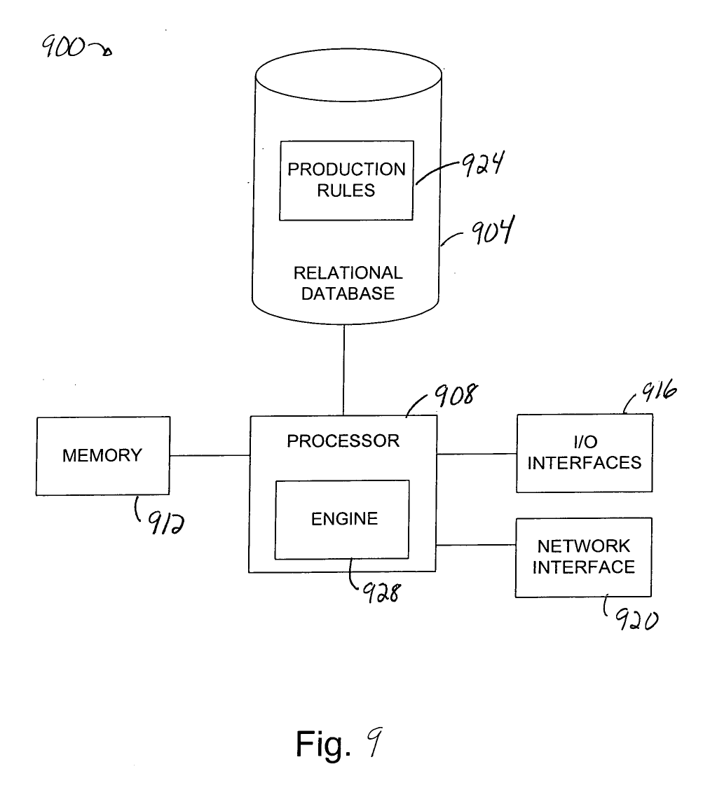

Indicators associated with approvers 510a-d may include integers which may be sorted or otherwise ordered. In one embodiment, the indicators may be N-tuples where N is any integer. When an N-tuple is a 6-tuple, for example, the lexicographic order of indicators associated with approvers 510a-d may be sorted along up to six dimensions in an ascending order. The dimensions of an N-tuple such as a 6-tuple may be associated with different layers of a hierarchical approver list structure, as will be described below with respect to FIG. 7.

The use of N-tuples such as 6-tuples to generate approver indicators allows an approval process to be parallelized. By way of example, since a first approver 510a and a second approver 510b have the same 6-tuple, first approver 510a and second approver 510b may be allowed to approve expense report 516 in a substantially parallel manner. While approvals requests that are provided to approvers 510a, 510b may be provided substantially simultaneously, approvers 510a, 510b may respond to the requests in an asynchronous manner.

As shown, a third approver 510c may be allowed to approve expense report 516 after both first approver 510a and second approver 510b have approved expense report 516 since the 6-tuple which effectively identifies third approver 510c is greater than the 6-tuple which effectively non-uniquely identifies first approver 510a and second approver 510b. Since the 6-tuple which effectively identifies third approver 510c differs from the 6-tuple which effectively non-uniquely identifies first approver 510a and second approver 510b, the first dimension at which the 6-tuples vary is used to determine the order in which approvers are notified of an approvals request. In the described embodiment, approver or approvers associated with the 6-tuple which has the numerically lower-valued first dimension at which the 6-tuples vary is notified first.

A fourth approver 510d is effectively non-uniquely identified by a 6-tuple which is greater than the 6-tuple which effectively non-uniquely identifies third approver 510c. Hence, fourth approver 510d is allowed to approve expense report 516 after third approver 510c has approved expense report 516. As a result, a transactions approval process is performed in parallel with respect to approvers 510a, 510b, while approvers 510c, 510d perform the approval process sequentially or in series with respect to each other and with respect to approvers 510a, 510b.

The parallelizing of transactions approvals processes enhances the flexibility of an approvals management system, and also increases the speed with which the transactions approvals processes may be completed. When more than one approver is able to approve a transaction such as an expense report substantially simultaneously, the overall time needed to complete an overall transactions approvals process may be reduced.

In addition to facilitating the parallelizing of transactions' approvals processes, the use of N-tuples to identify individual approvers also enables subordinate items, e.g., line items, associated with a transaction to have individual approver lists. By way of example, each subordinate item in an expense report may have an associated approver list. It should be appreciated that the overall expense report may have an overall approver list while each subordinate item may have a “subordinate” approver list.

Referring next to FIG. 6, a transactions approvals process which enables individual subordinate items of a transaction to have separate approver lists will be described in accordance with an embodiment of the present invention. A transaction, which is an expense report 614 in the described embodiment, includes a plurality of subordinate items 618a-c. Subordinate items 618a-c may generally be line items. It should be appreciated that although subordinate items 618a-c may be referred to as line items for ease of discussion, subordinate items 618a-c are not limited to being line items. As shown, a first subordinate item 618a has an associated approver list 624a which identifies at least one approver who is responsible for approver first subordinate item 618a. Similarly, a second subordinate item 618b has an associated approver list 624b and a third subordinate item 618c has an associated approver list 624c. It should be appreciated that approver lists 624a-c may include common approver indicators, i.e., a single approver may be associated with a plurality of approver lists 624a-c. The approver indicators, e.g., N-tuples, in each approver list 624a-c may be sorted in an ascending order such that the approvers having indicators with the lowest values receive notifications requesting approvals prior to those approvers having indicators with the highest values.

In one embodiment, approver lists 624a-c may effectively be processed substantially simultaneously. That is, more than one approver identified in approver lists 624a-c may substantially simultaneously receive notifications requesting approvers. Further, more than one approver in a single approver list 624a-c may also substantially simultaneously receive notifications requesting approval.

There may be several hierarchical approval levels associated with expense report 622. By way of example, approver lists 624a-c, which are each associated with a subordinate item 618a-c, respectively, are associated with a “first level” of approval. Once subordinate items 618a-c are approved, a “second level” of approval may occur. When there is a “second level” of approval, a group 622 which includes subordinate items 618a, 618b may be approved by approvers associated with an approver list 628. A “final level” of approval may include the approval of entire expense report 614 by approvers associated with an approver list 632. Approver list 632 may include approvers such as high-level managers, whereas approver list 628 may include approvers such as mid-level managers and approver lists 618a, 618b may include approvers such as lower level workers who report directly to mid-level managers.

As previously mentioned, the ability to parallelize transactions approvals is facilitated by a hierarchical tree structure associated with the generation of approvers lists which enables approvers to be sorted in a lexicographic order. The use of a hierarchical structure also enables extensible line item or subordinate item approver lists to be generated. FIG. 7 is a block diagram representation of an approver list hierarchy in accordance with an embodiment of the present invention. A hierarchy 700, as shown, may include six levels which may be used to generate a 6-tuple, i.e., each of the six levels may be associated with an integer such that a 6-tuple is formed when the integers are effectively put together. It should be appreciated that any number of levels may be included in hierarchy 700.

A first level in hierarchy 700 is an item class 704. In one embodiment, item class 704 may be associated with a line item, a cost center, or a project code. Any given transaction may generally be associated with any number of item classes, and any item class 704 may have its own approver list that is generated by rules that are specific to that item class 704. In addition, an item class 704 may define a set of attributes or business variables that are used with the rules that are specific to item class 704. An item indicator 708 is associated with a second level of hierarchy 700, and is arranged to identify a particular item of item class 794, while an item sub-list 712 is associated with a third level of hierarchy 700 and is used to identify subordinate entries associated with item class 794.

An action type 716, which is associated with a fourth level in hierarchy 700, may be used to define an action within item class 704, and a group or chain 720 associated with action type 716 may be used to generate more than one chain of authority for any particular action. By way of example, if an action involves the transfer of an employee from a first office to a second office, one chain of authority may be associated with allowing the employee to transfer out of the first office and a second chain of authority may be associated with allowing the employee to transfer into the second office. Within the chains of authority or groups, members of the chains of authority may be ordered in a lexicographic order. An individual approver order number 724 is arranged to identify an individual approver.

Each element or dimension in a 6-tuple formed using hierarchy 700 corresponds to a level within hierarchy 700. Within each 6-tuple formed using hierarchy 700, the highest level of hierarchy 700 is represented as the first element of the 6-tuple, whereas the last element of the 6-tuple represents the lowest level of hierarchy 700. In general, the value assigned to each dimension or value in a 6-tuple fro a given transaction may be determined by a set of meta-rules associated a production-rules engine. By way of example, when the meta-rules specify that all members of a given approver group are to be notified of an approvals request substantially simultaneously, the same group or chain member order number is assigned to substantially all members of that approver group.

As discussed above with respect to FIG. 6, subordinate items of a transaction may be approved prior to an entire transaction being approved. In one embodiment, each subordinate item of an expense report may have a separate approver list while the expense report has an overall expense report approver list. Referring next to FIG. 8, one method of processing a transaction, e.g., an expense report, which includes subordinate items, e.g., line items, with separate approver lists will be described in accordance with an embodiment of the present invention. Herein and after, a transaction will be referred to as an expense report and subordinate items will be referred to as line items for ease of discussion, although it should be understood that transactions are not limited to being expense reports and subordinate items are not limited to being line items.

A process 800 of approving an expense report begins at step 804 in which line items in an expense report are “sent” to line item approver lists. In other words, approvers in line item approver lists are notified of a request for approval which pertains to their respective line items. Such notifications of requests for approval may be sent serially, i.e., one line item may be processed at a time, or in parallel, i.e., a plurality of line items may be processed substantially simultaneously. In addition, a single line item may be sent to the approvers in its associated approver list either serially or in parallel.

After the line items are sent to the approvers listed in the line item approver lists, it is determined in step 808 whether all the line items have been approved by their associated approvers. As will be understood by those skilled in the art, approvers identified in approver lists typically send a notification to a production rules engine or similar apparatus which indicates whether approval has been granted. If it is determined in step 808 that not all line items have been approved, the indication is that at least one approver has declined to approver a particular line item he or she had been asked to approve. Accordingly, process flow moves to step 812 in which the expense report is flagged as having an unapproved line item, and the process of approving an expense report is terminated.

Alternatively, if it is determined in step 808 that all line items have been approved, then the entire expense report is sent to the approvers listed in an approver list which corresponds to the entire expense report in step 816 for approval. Such an approver list may be considered to be a superordinate approver list. A determination is then made in step 820 as to whether the entire expense report is approved by the approvers listed in the approver list for the entire expense report. It should be appreciated that such a determination is generally made after responses, both affirmative and negative, have been received from the approvers listed in the approver list for the entire expense report.

If it is determined in step 820 that the entire expense report is not approved, the implication is that at least one approver listed in the approver list for the entire expense report has found at least one line item in the expense report objectionable. As such, in step 824, the expense report is flagged as not being approved, and the process of approving an expense report is terminated. Returning to step 820, if it is determined that the entire expense report is approved, then the expense report may be flagged as approved in step 828, and the process of approving an expense report is completed.

An overall transactions approvals management system which is used to generate approver lists and to process transactions may include a variety of different components. FIG. 9 is a diagrammatic representation of a transactions approvals management system in accordance with an embodiment of the present invention. A transactions approvals management system 900 may be arranged to support Oracle Approvals Management software available from Oracle International Corporation of Redwood Shores, Calif. In general, transactions approvals management system 900 includes production rules 924 which are stored on a relational database 904 and a production rules engine 928 which executes using a processor 908. Production rules engine 928 is arranged to execute an algorithm, as for example a greedy algorithm, which enables approver lists to be generated and notifications requesting approval to be transmitted to appropriate approvals.

Processor 908 has access to relational database 904, and may have access to a network of computing devices. Access to a network of computing devices, e.g., computing devices operated by various approvers, may be achieved through a network interface 920 that enables communication between processor 908 and other computing devices through signals embodied in a carrier wave. A memory 912 on which code devices associated with transactions approvals management software may be stored, is coupled to processor 908 such that engine 928 may have access to memory 912. Processor 908 may also be coupled to input/output interfaces 916 which may include, but are not limited to, keyboards, cursor control devices, and the like.

Although only a few embodiments of the present invention have been described, it should be understood that the present invention may be embodied in many other specific forms without departing from the spirit or the scope of the present invention. By way of example, production rules have been described as being stored within a relational database of an overall system which allows rules to be eliminated before evaluation and supports a hierarchical approver list structure. However, production rules may be stored using any suitable apparatus, i.e., production rules are not limited to being stored on a relational database. For instance, production rules within an overall system which allows rules to be eliminated before evaluation and supports a hierarchical approver list structure may be stored on any suitable database or memory apparatus, such as a memory apparatus which enables production rules to be stored in files.

PL/SQL has been described as being a programming language which is suitable for use in implementing the present invention. In general, substantially any suitable programming language, including other programming languages which do not support pointer or reference constructs, may be used to create source code which implements the present invention. That is, an efficient production-rules engine as discussed above is not limited to be associated with PL/SQL source code.

While the number of levels in a hierarchical approver list structure has been described as including approximately six levels, it should be appreciated that the number of levels may vary widely. That is, an N-tuple which is used to generate an indicator for an approver may be such that N is any integer with a value of at least one. Further, indicators may be generated using constructs other than N-tuples, although N-tuples allow for the efficient generation and sorting of indicators. Indicators may also be generated using a variety of different constructs which include, but are not limited to, constructs which utilize alphabet characters or a combination of alphabet characters and numeric characters.

The features of the present invention may generally be implemented together or separately. For example, a system which sorts conditions and eliminates some rules in order to prevent having to evaluate all rules may not necessarily allow for the parallelizing of transactions approvals processes. Conversely, a system that allows for the parallelizing of transactions approvals processes may not necessarily allow for eliminating some rules from having to be evaluated.

A production rules engine has been described as utilizing a greedy algorithm. A greedy algorithm may be created using a variety of different algorithm solutions. One suitable algorithm solution is a RETE algorithm solution. Additionally, the programming language used to create a production rule engine may also vary widely. By way of example, although PL/SQL is a particularly suitable programming language in that it promotes more direct access to a database which lacks a pointer or a reference construct, other programming languages may also be used to create a production rule engine.

In general, the steps associated with methods of the present invention may vary widely. Steps may be added, removed, altered, and reordered without departing from the spirit or the scope of the present invention. Therefore, the present examples are to be considered as illustrative and not restrictive, and the invention is not to be limited to the details given herein, but may be modified within the scope of the appended claims.

What is claimed is:

1. A management approval system comprising:
a database, the database being arranged to store a set of production rules; and
an engine, the engine being arranged to receive data and to utilize the data to process the set of production rules, the data including a plurality of conditions having associated counters, wherein the engine is arranged to sort the plurality of conditions using the associated counters into an order and to evaluate the plurality of conditions based on the order.

2. The management approval system of claim 1 wherein when a first condition of the plurality of conditions is evaluated, the engine is further arranged to determine when the first condition evaluates in a first manner, wherein when the first condition evaluates in the first manner, the engine is still further arranged to substantially locate any production rules of the set of production rules which utilize the first condition in the database and to substantially eliminate the production rules of the set of production rules which utilize the first condition from being evaluated.

3. The management approval system of claim 1 wherein the associated counters are use counts, and the engine is arranged to sort the plurality of conditions such that a first condition of the plurality of conditions with a highest use count is evaluated first.

4. The management approval system of claim 1 wherein the engine is arranged to evaluate the production rules.

5. The management approval system of claim 1 wherein the data is associated with a transaction, and the engine arranged to generate at least one ordered list of approvers for the transaction.

6. The management approval system of claim 5 wherein the at least one ordered list of approvers includes a first ordered list of approvers and a second ordered list of approvers.

7. The management approval system of claim 6 wherein the first ordered list of approvers is associated with a first subordinate item of the transaction and the second ordered list of approvers is associated with a second subordinate item of the transaction.

8. The management approval system of claim 7 wherein the at least one ordered list of approvers includes a third ordered list of approvers, wherein the third ordered list of approvers is associated with the first subordinate item of the transaction and the second subordinate item of the transaction.

9. The management approval system of claim 5 wherein the engine is arranged to send a notification to a first approver of the at least one ordered list of approvers and to a second approver of the at least one ordered list of approvers substantially simultaneously.

10. The management approval system of claim 1 wherein the database is a relational database.

11. A method for processing a transaction using an approvals management system, the approvers management system including an engine and a database on which a plurality of production rules are stored, the method comprising:
sorting a plurality of conditions, the plurality of conditions being associated with the transaction, wherein sorting the plurality of conditions includes ordering the plurality of conditions in an approximately deterministic order;
evaluating the plurality of conditions in the approximately deterministic order; and
processing the plurality of production rules based on the evaluated plurality of conditions, wherein processing the plurality of production rules based on the evaluated plurality of conditions includes eliminating at least a first production rule of the plurality of production rules from being evaluated.

12. The method of claim 11 wherein the approximately deterministic order is an order based on use counts associated with the plurality of conditions.

13. The method of claim 11 wherein evaluating the conditions in the approximately deterministic order includes identifying at least one condition that evaluates to a false value, and wherein processing the plurality of production rules based on the evaluated plurality of conditions includes identifying the first production rule of the plurality of production rules which is associated with the at least one condition.

14. The method of claim 11 further including:
evaluating substantially all production rules of the plurality of production rules that are not eliminated from being evaluated.

15. The method of claim 14 further including generating at least one ordered list of approvers for the transaction.

16. The method of claim 15 wherein the transaction includes a first item and a second item, and the at least one ordered list of approvers includes a first list of approvers associated with the first item and a second list of approvers associated with the second item.

17. The method of claim 16 further including:
sending a first approval request notification to a first approver of the first list of approvers and sending a second approval request notification to a second approver of the second list of approvers substantially simultaneously.

18. The method of claim 15 further including:
sending a notification to a first approver of the at least one ordered list of approvers and to a second approver of the at least one ordered list of approvers substantially simultaneously.

19. The method of claim 15 wherein generating the at least one ordered list of approvers includes assigning N-tuples to approvers identified in the at least one ordered list of approvers and sorting the approvers using the N-tuples.

20. The method of claim 11 wherein the database is a relational database.

21. A computer program product for processing a transaction within an approvals management system that includes an engine and a database on which a plurality of production rules are stored, the computer program product comprising:
code devices that cause a plurality of conditions to be sorted, the plurality of conditions being associated with the transaction, wherein the code devices that cause the plurality of conditions to be sorted include code devices that cause the plurality of conditions to be sorted in an approximately deterministic order;
code devices that cause the plurality of conditions to be evaluated in the approximately deterministic order;
code devices that cause the plurality of production rules based on the evaluated plurality of conditions to be processed, wherein the code devices that cause the plurality of production rules based on the evaluated plurality of conditions to be processed include code devices that cause at least a first production rule of the plurality of production rules to be eliminated from being evaluated; and
a computer-readable medium that stores the code devices.

22. The computer program product of claim 21 wherein the code devices that cause the conditions to be evaluated in the approximately deterministic order include code devices that cause at least one condition that evaluates to a false value to be identified, and wherein the code devices that cause the plurality of production rules to be processed based on the evaluated plurality of conditions include code devices that cause the first production rule of the plurality of production rules which is associated with the at least one condition to be identified.

23. The computer program product of claim 22 further including code devices that cause at least one ordered list of approvers for the transaction to be generated and
code devices that cause a notification to be sent to a first approver of the at least one ordered list of approvers and to a second approver of the at least one ordered list of approvers substantially simultaneously.

24. The computer program product of claim 23 wherein the code devices that cause the at least one ordered list of approvers to be generated include code devices that cause N-tuples to be assigned to approvers identified in the at least one ordered list of approvers and code devices that cause the approvers to be sorted using the N-tuples.

25. The computer program product of claim 21 wherein the code devices include PL/SQL source code devices.

26. A method for processing a transaction using an approvals management system, the approvals management system including an engine and a relational database on which a plurality of production rules are stored, the method comprising:
generating at least one ordered list of approvers for the transaction, the approvers having associated indicators; and
notifying a plurality of the approvers substantially simultaneously of a request for approval.

27. The method of claim 26 wherein the associated indicators are N-tuples, and generating the at least one ordered list of approvers for the transaction includes sorting the N-tuples.

28. The method of claim 26 wherein the at least one ordered list of approvers for the transaction includes a first list and a second list, the first list being associated with a first subordinate item of the transaction and the second list being associated with a second subordinate item of the transaction.

29. A method for processing a transaction using an approvals management system, the approvals management system including an engine and a relational database on which a plurality of production rules are stored, the transaction including a first subordinate item and a second subordinate item, the method comprising:
generating a first ordered list of approvers for the first subordinate item, each approver of the first ordered list of approvers having associated indicators;
generating a second ordered list of approvers for the second subordinate item, each approver of the second ordered list of approvers having associated indicators; and
notifying a first approver identified in the first ordered list of approvers and a second approver identified in the second ordered list of approvers substantially simultaneously of a request for approval.

30. The method of claim 29 further including:
generating a third ordered list of approvers for the transaction, each approver of the third ordered list of approvers having associated indicators, the third ordered list being associated with both the first subordinate item and the second subordinate item.
